(19) United States
(12) Patent Application Publication
(10) Pub. No.: US 2008/0306208 A1
(43) Pub. Date: Dec. 11, 2008

(54) Rapid Surface Curing Silicone Compositions

(75) Inventors: Thomas Fay-Oy Lim, Killingworth, CT (US); Hsien-Kun Chu, Wethersfield, CT (US); Robert P. Cross, Rocky Hill, CT (US); Mathias E. Liistro, JR., Plainville, CT (US); David P. Dworak, East Hartford, CT (US); Paul Borucki, Rocky Hill, CT (US); Scott Senuta, Leadyard, CT (US); Daniela Bathelt, Dusseldorf (DE); Thomas Bachon, Dusseldorf (DE)

Correspondence Address: LOCTITE CORPORATION, 1001 TROUT BROOK CROSSING, ROCKY HILL, CT, 06067, US

(73) Assignees: Henkel Corporation, Rocky Hill, CT (US); Henkel KGaA, Dusseldorf (GA)

(21) Appl. No.: 12/093,904

(22) PCT Filed: Nov. 16, 2006
(86) PCT No.: PCT/US06/44678

§ 371 Date: May 15, 2008

Related U.S. Application Data
(60) Provisional application No. 60/738,170, filed on Nov. 18, 2005.

(51) Int. Cl. C08L 83/04; C08G 77/04

(52) U.S. Cl. 524/588; 528/33; 525/477

(57) ABSTRACT

The present invention relates to a method of preparing fast curing silicone RTV compositions by reacting an amino endcapped silicone with an isocyanato functionalized silane, and to compositions formed thereby. In particular, the present invention provides compositions which include silicones endcapped with silanes which contain α-ureas. Illustrative of the inventive compositions are those which include a polymer of Formula (I):

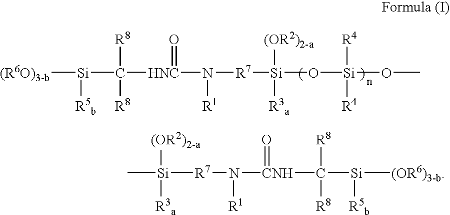

### FIELD OF THE INVENTION

The present invention relates to a method of preparing fast curing silicone RTV compositions by reacting an amino endcapped silicone with an isocyanato functionalized silane, and to compositions formed thereby. In particular, the present invention provides compositions which include silicones endcapped with silanes which contain α-ureas.

### BRIEF DESCRIPTION OF RELATED TECHNOLOGY

Moisture curable silicone adhesives are used in a broad range of applications, including construction, electronic devices, package assembly, and appliance assembly. Typically, curable adhesives used in these applications have been tailored to provide the strength and toughness required for the application at hand. In addition to these properties, rapid cure speeds and product stability are often desired.

Alkoxy-terminated polysiloxanes have been used to prepare moisture curable silicone adhesives with desirable properties. These reactive polysiloxanes are prepared by endcapping silanol terminated silicones with alkoxysilane crosslinkers in the presence of a catalyst. The endcapped silanols may then be cured (i.e. the cross-linking of the reactive silicones) by exposure to ambient conditions in the presence of a catalyst. The moisture in the air hydrolyzes the alkoxy groups on the silicon atom(s) to form through a condensation reaction a siloxane linkage that advances the cure of the silicone material.

Although effective, these silicone adhesives often exhibit cure speeds that are too slow for certain applications. In particular, in some applications it is desirable to use an adhesive that has a quick skin-over time. There are advantages to using compositions having a quick skin-over time, including the ability to manipulate substrates to which the composition has been applied without disturbing the composition as it cures.

Some polymeric compositions, such as those of cyanoacrylates have rapid-cure abilities, but suffer from the disadvantage that they are somewhat stiff and rigid, and do not possess the softness and flexibility of silicones. Therefore, it is desirable to prepare moisture-curable silicones which retain their softness and pliability when cured, but have cure speeds approaching those of rapid-curing polymers such as cyanoacrylates.

### SUMMARY OF THE INVENTION

In one aspect of the present invention, there is provided a composition of Formula (I):

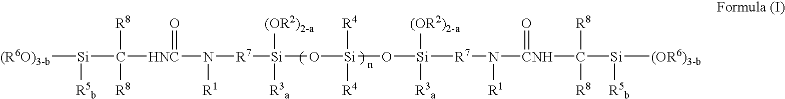

In still another aspect of the present invention, there is provided a method for making a composition, which includes the steps of:

a) mixing:
i. a polymer of Formula (III):

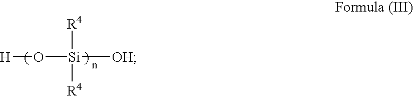

and
ii. at least two equivalents of a compound of Formula (IV):

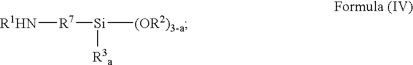

and

b) mixing the reaction product of step a) with at least two equivalents of a compound of Formula (V):

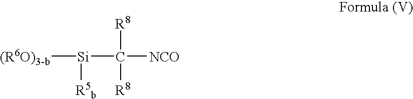

The present invention also provides a method for making a composition, which includes the step of mixing:

i. a polymer having of Formula (II):

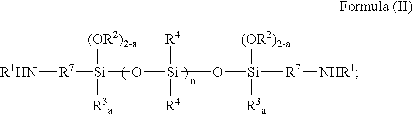

and

ii. at least two equivalents of a compound of Formula (V):

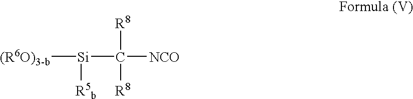

In another aspect, the present invention provides a composition which includes the reaction product of:

a) the reaction product of:
i. a polymer of Formula (III):

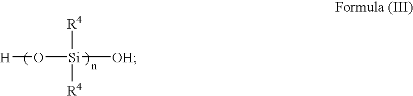

and
ii. a compound of Formula (IV):

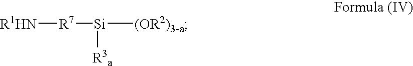

and

b) a compound of Formula (V):

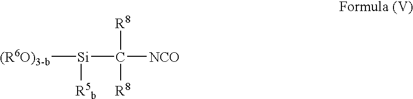

Still another aspect of the present invention provides a composition which includes the reaction product of:

i. a polymer having of Formula (II):

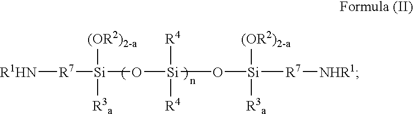

and

ii. at least two equivalents of a compound of Formula (V):

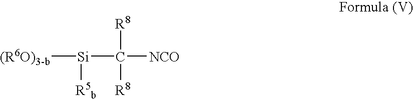

Yet another aspect of the present invention provides a method of using a composition which includes a polymer of Formula (I):

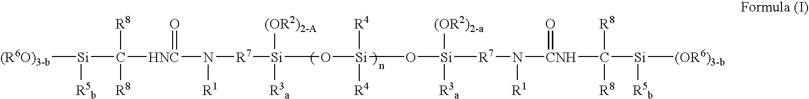

In each of Formulas (I) through (V) shown above,
R¹ and R⁸ are each, independently, a member selected from the group consisting of H and a C₁ to C₁₀ hydrocarbon radical;
R², R³, R⁴, R⁵, and R⁶ are each, independently, a C₁ to C₁₀ hydrocarbon radical;
R⁷ in each occurrence may be the same or different and is a C₁ to C₁₀ hydrocarbon diradical;
n is 1 to about 1,200;
a is 0, 1, or 2; and
b is 0 or 1.

### DETAILED DESCRIPTION OF THE INVENTION

The present invention provides silicone compositions capable of rapid moisture cure.

As used herein, the terms “hydrocarbon radical” and “hydrocarbon diradical” are intended to refer to radicals and diradicals, respectively, which are primarily composed of carbon and hydrogen atoms. Thus, the term encompasses aliphatic groups such as alkyl, alkenyl, and alkynyl groups; aromatic groups such as phenyl; and alicyclic groups such as cycloalkyl and cycloalkenyl. Hydrocarbon radicals of the invention may include heteroatoms to the extent that the heteroatoms do not detract from the hydrocarbon nature of the groups. Accordingly, hydrocarbon groups may include such functionally groups as ethers, alkoxides, carbonyls, esters, amino groups, cyano groups, sulfides, sulfates, sulfoxides, sulfones, and sulfones.

The hydrocarbon, alkyl, and phenyl radicals and diradicals of the present invention may be optionally substituted. As used herein the term “optionally substituted” is intended to mean that one or more hydrogens on a group may be replaced with a corresponding number of substituents selected from alkyl, alkenyl, alkynyl, aryl, halo, haloalkyl, haloalkenyl, haloalkynyl, haloaryl, hydroxy, alkoxy, alkenyloxy, alkynyloxy, aryloxy, carboxy, benzyloxy, haloalkoxy, haloalkenyloxy, haloalkynyloxy, haloaryloxy, nitro, nitroalkyl, nitroalkenyl, nitroalkynyl, nitroaryl, nitroheterocyclyl, azido, amino, alkylamino, alkenylamino, alkynylamino, arylamino, benzylamino, acyl, alkenylacyl, alkynylacyl, arylacyl, acylamino, acyloxy, aldehydro, alkylsulphonyl, arylsulphonyl, alkylsulphonylamino, arylsulphonylamino, alkylsulphonyloxy, arylsulphonyloxy, heterocyclyl, heterocycloxy, helerocyclylamino, haloheterocyclyl, alkylsulphenyl, arylsulphenyl, carboalkoxy, carboaryloxy, mercapto, alkylthio, arylthio, acylthio and the like.

As used herein, the terms “halo” and “halogen” are intended to be synonymous, and both are intended to include chlorine, fluorine, bromine, and iodine.

The present invention is directed to RTV compositions, of which Formula (I) is representative:

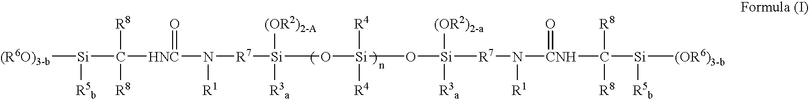

R¹ in each occurrence may be the same or different and H and a C₁ to C₁₀ hydrocarbon radical. In a desirable aspect, R¹ is selected from H and C₁ to C₄ alkyl.

R² and R⁶ are each, independently, a C₁ to C₁₀ hydrocarbon radical. Substituents R² and R⁶, in combination with the respective oxygens to which they are attached, form hydrolyzable groups, which provide the compositions of the present invention with their ability to undergo room temperature vulcanization (RTV) cure. RTV cure typically occurs through exposure of the compositions of the invention to moisture. The compositions of the present invention may cure to a flexible resin via a RTV (room temperature vulcanization) mechanism. Thus, a further aspect of the invention relates to the cured polymer formed by reaction of the silicone polymer compositions of the invention upon exposure to moisture. The presence of hydrolyzable moisture curing groups, such as alkoxy groups, permits the polymer to undergo moisture cure. Suitable hydrolyzable groups include alkoxy groups such as methoxy, ethoxy, propoxy, and butoxy; acyloxy groups such acetoxy; aryloxy groups such as phenoxy; oximinoxy groups such as methylethyloximinoxy; enoxy groups such as isopropenoxy; and alkoxyalkyl groups such as CH₃OCH₂CH₂—. Larger groups such as propoxy and butoxy are slower to react than smaller groups such as methoxy and ethoxy. The rate at which the compositions of the present invention undergo moisture cure can be tailored by choosing appropriate groups for substituents R² and R⁶. A mixture of different R² groups can be positioned on a single silicon atom to influence the cure of the composition. Likewise, a mixture of different R⁶ groups can be positioned on a single silicon atom to influence the cure of the composition. Advantageously, R² and 16 may be C₁ to C₄ alkyl. More advantageously, R² and R⁶ are methyl or ethyl

The C₁ linkage between the urea and silicon atom in the polymer of Formula (I) is believed to contribute to its ability to rapidly moisture-cure. R⁸ in each occurrence may be the same or different, and is a member selected from the group consisting of H and a C₁ to C₁₀ hydrocarbon radical. Advantageously, R⁸ is H.

R³ and R⁵ in each occurrence may be the same or different, and are each, independently, a C₁ to C₁₀ hydrocarbon radical. R³ and R⁵ are desirably C₁ to C₄ alkyl. More advantageously, R³ and R⁵ are methyl.

R⁴ in each occurrence may be the same or different and is a C₁ to C₁₀ hydrocarbon radical. Advantageously, R⁴ is C₁ to C₄ alkyl. For most commercial applications, R⁴ will desirably be methyl, due to the wide availability of polydimethylsiloxane starting material which is advantageously used in the synthesis of the compositions of the invention. In another desirable aspect, R⁴ may also be phenyl.

The molecular weights of the silicone may vary and may be chosen to tailor the final product characteristics. The number of repeating units, n, can be varied to achieve specific molecular weights, viscosities, and other chemical or physical properties. Generally, n is an integer such that the viscosity is from about 25 cps to about 2,500,000 cps at 250° C., such as when n is from 1 to about 1,200 and desirably from about 10 to about 1,000. Examples of useful molecular weights of the polyalkylsiloxanes include molecular weights of about 500 to about 50,000 atomic mass units. Advantageously, the average molecular weight of the silicone is about 10,000 to about 8,000 atomic mass units.

R⁷ in each occurrence may be the same or different and is a C₁ to C₁₀ hydrocarbon diradical. Advantageously, R⁷ is C₁ to C₁₀ alkylene. More advantageously, R⁷ is methylene, propylene, or isobutylene.

Variable “a” in the polymer of Formula (I) is 0, 1, or 2. Variable “b” is 0 or 1. Variables “a” and “b” indicate the number of hydrocarbyl groups, respectively, on the pendant and terminal silicon atoms of the polymer of Formula (I). Correspondingly, the variables “2-a” and “3-b” indicate the number of hydrocarbyloxy substituents on the respectively silicon atoms.

The inventive compositions may advantageously include one or more moisture-cure catalysts. The cure system used in the moisture curable compositions of the present invention includes, but is not limited to, catalysts or other reagents which act to accelerate or otherwise promote the curing of the composition of the invention. Suitable moisture-cure catalysts include compounds which contain such metals as titanium, tin, or zirconium. Illustrative examples of the titanium compounds include tetraisopropyl titanate and tetrabutyl titanate. Illustrative examples of the tin compounds include dibutyltin dilaurate, dibutyltin diacetate, dioctyltindicarboxylate, dimethyltindicarboxylate, and dibutyltindioctoate. Illustrative examples of the zirconium compounds include zirconium octanoate. Additionally, organic amines such as tetramethylguandinamines, diazabicyclo[5.4.0]undec-7-ene (DBU), triethylamine, and the like may be used. The moisture-cure catalysts are employed in an amount sufficient to effectuate moisture-cure, which generally is from about 0.01% to about 5.00% by weight, and advantageously from about 0.1% to about 1.0% by weight.

A variety of additional useful components may be added to the present inventive compositions. For example, additional crosslinkers may be added. Such crosslinkers include condensable silanes such as alkoxy silanes, acetoxy silanes, enoxy silanes, oximino silanes, amino silanes and combinations thereof. Other suitable silanes include vinyl trimethoxy silane, vinyltrimethoxysilane, vinyltriisopropenoxysilane, and alpha functionalized silanes. The condensable silanes may be present in amounts of about 0.5% to about 10% by weight of the composition. A more desirable range would be 0.5-5.0%.

Fillers optionally may be included in the compositions of the present invention. Generally, any suitable mineral, carbonaceous, glass, or ceramic filler may be used, including, but not limited to: fumed silica; clay; metal salts of carbonates; sulfates; phosphates; carbon black; metal oxides; titanium dioxide; ferric oxide; aluminum oxide; zinc oxide; quartz; zirconium silicate; gypsum; silicium nitride; boron nitride; zeolite; glass; plastic powder; and combinations thereof. The filler may be present in the composition in any suitable concentration in the curable silicone composition. Generally, concentrations of from about 5% to about 80% by weight of the composition are sufficient. However, a more desirable range would be 20-60%.

Among the more desirable fillers are reinforcing silicas. The silica may be a fumed silica, which may be untreated-(hydrophilic) or treated with an adjuvant so as to render it hydrophobic. The filmed silica should be present at a level of at least about 5% by weight of the composition in order to obtain any substantial reinforcing effect. Although optimal silica levels vary depending on the characteristics of the particular silica, it has generally been observed that the thixotropic effects of the silica produce compositions of impractically high viscosity before maximum reinforcing effect is reached. Hydrophobic silicas tend to display lower thixotropic ratios and therefore greater amounts can be included in a composition of desired consistency. In choosing the silica level, therefore, desired reinforcement and practical viscosities must be balanced. A particularly desirable fumed silica is R8200 by Degussa®.

In some embodiments of the present invention, it may be desirable to incorporate a dry filler. For example, a moisture curable pre-mix composition may include the reactive polymer of Formula I and at least one dry filler. Such dry fillers generally have a water content of less than about 0.5% by weight of the composition. Such compositions desirably are substantially free of added moisture, thereby preventing premature curing of the reactive polyorganosiloxane. The pre-mix compositions also may include additional reactive silanes, adhesion promoters or combinations thereof.

Adhesion promoters also may be included in the moisture curable compositions. An adhesion promoter may act to enhance the adhesive character of the moisture curable composition for a specific substrate (i.e., metal, glass, plastics, ceramic, and blends thereof). Any suitable adhesion promoter may be employed for such purpose, depending on the specific substrate elements employed in a given application. Various organosilane compounds, particularly aminofunctional alkoxysilanes, may be desired.

Suitable organosilane adhesion promoters include, for example, 3-aminopropyltriethoxysilane, 3-aminopropyltrimethoxysilane, 3-aminopropylmethyldiethoxysilane, 3-aminopropylmethyldimethoxysilane, methylaminopropyltrimethoxysilane, 1,3,5-tris(trimethylsilylpropyl)isocyanurate, 3-glycidoxypropyltrimethoxysilane, 3-glycidoxypropylethyldimethoxysilane, 2-glycidoxyethyltrimethoxysilane, 2-cyanoethyltrimethoxysilane, 3-cyanopropyltriethoxysilane, isocyanatopropyltriethoxysilane, isocyanatopropyltrimethoxysilane, and combinations thereof.

Adhesion promoters, when present, may be used in amounts of about 0.1% to about 10% by weight of the composition. Desirably, the adhesion promoter is present from about 0.2% to about 2.0% by weight of the composition.

The compositions also may include any number of optional additives, such as pigments or dyes, plasticizers, thixotropic agents, alcohol scavengers, stabilizers, anti-oxidants, flame retardants, UV-stabilizers, biocides, fungicides, thermal stabilizing agents, rheological additives, tackifiers, and the like or combinations thereof. These additives should be present in amounts suitable to effectuate their intended purpose.

The present invention also provides methods for preparing compositions which include a polymer of Formula (I). One approach to preparing the polymer of Formula (I) includes the steps of:

a) mixing:
i. a polymer of Formula (III):

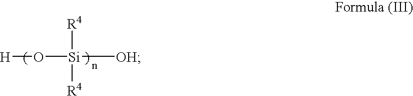

with
ii. at least two equivalents of a compound of Formula (IV):

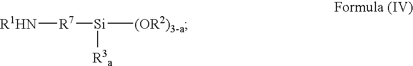

and

b) mixing the reaction product of step a) with at least two equivalents of a compound of Formula (V):

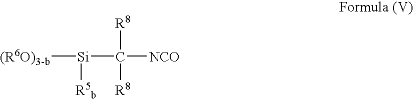

where R¹, R², R³, R⁴, R⁵, R⁶, R⁷, R⁸, a, b, and n are as discussed hereinabove.

As shown below in Scheme 1, reaction of the hydroxy-terminated siloxane of Formula (III) with the aminoalkylenealkoxysilane of Formula (III) in step a) produces the aminoalkylenealkoxy terminated polydialkylsiloxane of Formula (II). This procedure is described in U.S. Pat. No. 6,750,309 B1, assigned to Henkel Corporation, and is incorporated herein in its entirety. Advantageously, relative to the polymer of Formula (III), two molar equivalents of the compound of Formula (IV) may be used. An amount in excess of two molar equivalents may advantageously be used to ensure complete endcapping of the polymer of Formula (I).

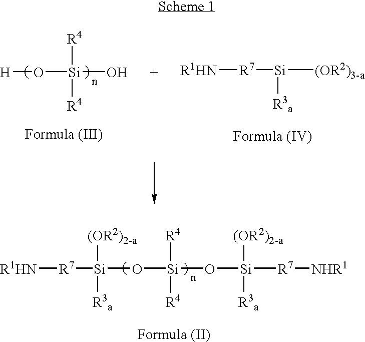

The reaction product of step a) is then mixed with the isocyanatosilane of Formula (V) containing a C₁ linkage, as shown below in Scheme 2, thereby forming the polymer of Formula (I), which contains a urea linkage at each end. To ensure complete endcapping, at least two equivalents of the isocyanatosilane may be used. However, an amount significantly in excess of two equivalents is advantageously avoided, as this helps minimize the presence of unreacted isocyanates that may be left over.

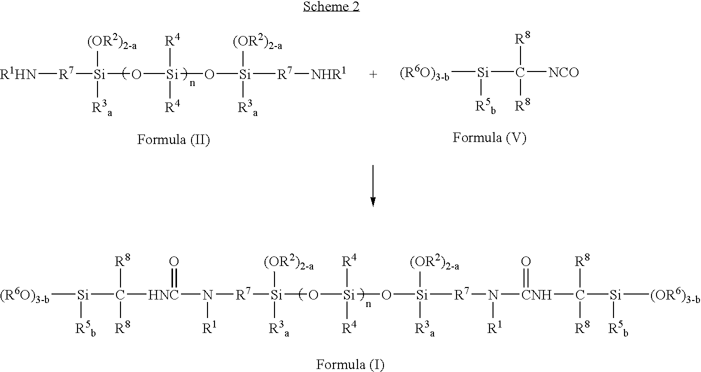

Accordingly, in another aspect, the present invention is also directed to a method for producing compositions including polymers of Formula (I) via reaction of the polymer of Formula (II) with the isocyanate of Formula (V). The method includes the step of reacting:

i. a polymer having of Formula (II):

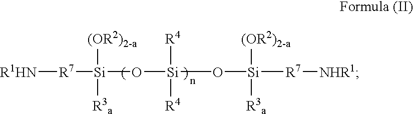

with

ii. at least two equivalents of a compound of Formula (V):

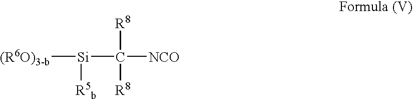

where R¹, R², R³, R⁴, R⁵, R⁶, R⁷, R⁵, a, b, and n are as discussed hereinabove.

The present invention additionally encompasses the reaction products of the methods described hereinabove for producing compositions which include a polymer of Formula (I).

Also provided by the present invention is a method of using a composition which includes a polymer of Formula (I):

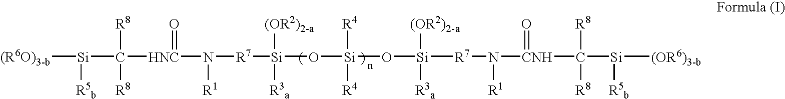

the method including the steps of:

a) providing the composition;

b) applying the composition onto a substrate;

c) and permitting the composition to cure,

where R¹, R², R³, R⁴, R⁵, R⁶, R⁷, R⁸, a, b, and n are as discussed hereinabove.

The compositions may be used, for example, to seal or bond substrates, such as, but not limited to, gaskets. In gasketing applications, the moisture curable composition may be applied to one of the substrates which will form part of the gasket, cured or at least partially cured, and then joined to a second substrate to form a gasket assembly. Such gasketing applications include, for example, form-in-place gaskets. For instance, the compositions may be applied to a substrate and subjected to curing conditions. The compositions may be used to seal together substrates by applying the composition to at least one of two substrate surfaces, mating the substrate surfaces in an abutting relationship to form an assembly, and exposing the composition to moisture to effect cure. The substrates should be maintained in the abutting relationship for a time sufficient to effect cure.

Advantageously, the composition before use will be provided in container sealed to minimize exposure to moisture.

### EXAMPLES

### Synthetic Example 1

### Fluid A

### Synthesis of Aminopropyldimethoxysilyl Terminated Polydimethylsiloxane

In a 2-L reaction flask was charged with 1000 g of a silanol terminated polydimethylsiloxane (3500 cps). Aminopropyltrimethoxysilane (14.06 g) was then added to the liquid. The mixture was heated with vigorous mixing to 70° C. followed by vacuum stripping off the volatile component until the mixture was clear.

### Synthetic Example 2

### Fluid B

### Synthesis of Ethylaminoisobutyldimethoxysilyl Terminated Polydimethylsiloxane

The same procedure as in Example 1 was used except aminopropyltrimethoxysilane was replaced with ethylaminoisobutyltrimethoxysilane (17.36 g).

### Synthetic Example 3

### Fluid C

### Synthesis of Cyclohexylaminomethyldimethoxysilyl Terminated Polydimethylsiloxane

The same procedure as in Example 1 was used except aminopropyltrimethoxysilane was replaced with cyclohexylaminomethyltrimethoxysilane (18.31 g).

### Synthetic Example 4

### Fluid D

### Synthesis of Trimethoxysilylmethylureidopropyldimethoxysilyl Terminated Polydimethylsiloxane

Five hundred grams of Fluid B prepared from Synthetic Example 2 was charged into a 1-L reaction flask. To this fluid was further added 6.32 g of isocyanatomethyltrimethoxysilane with vigorous mixing followed by vacuum de-airing.

### Synthetic Example 5

### Fluid E

### Synthesis of Methyldimethoxysilylmethylureidopropyldimethoxysilyl Terminated Polydimethylsiloxane

The same procedure as in Example 4 was used except isocyanatomethyltrimethoxysilane was replaced with 5.75 g of isocyanatomethyldimethoxysilane.

Table 1 shows the components included in typical formulations of the invention, designated Formulations 1 to 5. Fluids A to E were each formulated with Degussa® fumed silica R8200 and a catalysts consisting of a 2:1 mixture of DBU and dimethyltindicarboxylate.

TABLE 1

| | Formulation | | | | |
|---|---|---|---|---|---|
| | 1 | 2 | 3 | 4 | 5 |
| Base Polymer | Fluid A | Fluid B | Fluid C | Fluid D | Fluid E |
| Base Amount | 76.75 | 76.75 | 76.75 | 76.75 | 76.75 |
| Fumed Silica | 23.02 | 23.02 | 23.02 | 23.02 | 23.02 |
| Catalyst | 0.23 | 0.23 | 0.23 | 0.23 | 0.23 |

Table 2 shows the skin-over time for Formulations 1 to 5. As is shown in the Table, each of the Formulations had a maximum skin time of five minutes, with Formulations 3 to 5 having a skin time of only 5 seconds.

TABLE 2

| Formulation | 1 | 2 | 3 | 4 | 5 |
|---|---|---|---|---|---|
| Skin-over time | 5 min. | 5 min. | 5 sec. | 5 sec. | 5 sec. |

Table 3 shows various physical characteristics of the cured Formulations 1 to 5 after curing at room temperature for 5 days.

TABLE 3

| Formulation | 1 | 2 | 3 | 4 | 5 |
|---|---|---|---|---|---|
| Shore A | 28 | 38 | 44 | 49 | 44 |
| Tensile (psi) | 127 | 222 | 283 | 343 | 244 |
| Elongation (%) | 124 | 161 | 231 | 112 | 96 |
| Modulus 50% | 53 | 89 | 96 | 168 | 140 |
| Modulus 100% | 99 | 145 | 139 | 272 | 232 |

Table 4 shows physical data of Formulations 1 to 5 after the cured samples were further subjected to 14 days of heat and humidity at a temperature of 85° C. and 85% humidity conditions. As can be seen, Formulations 4 and 5 are most resistant to heat and humidity aging.

TABLE 4

| Formulation | 1 | 2 | 3 | 4 | 5 |
|---|---|---|---|---|---|
| Shore A | 12 | 29 | 32 | 38 | 32 |
| Tensile (psi) | 80 | 205 | 117 | 224 | 158 |
| Elongation (%) | 181 | 217 | 88 | 139 | 128 |
| Modulus 50% | 16 | 56 | 77 | 81 | 66 |
| Modulus 100% | 37 | 100 | — | 162 | 127 |

What is claimed is:

1. A composition comprising a polymer of Formula (I): 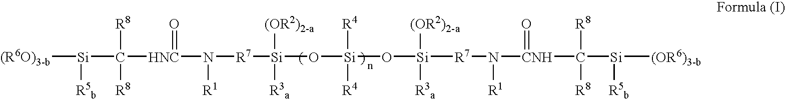
wherein
R¹ and R⁸ are each, independently, selected from H and a C₁ to C₁₀ hydrocarbon radical;
R², R³, R⁴, R⁵, and R⁶ are each, independently, a C₁ to C₁₀ hydrocarbon radical;
R⁷ in each occurrence may be the same or different and is a C₁ to C₁₀ hydrocarbon diradical;
n is 1 to about 1,200;
a is 0, 1, or 2; and
b is 0 or 1.

2. The composition of claim 1,
wherein
R¹ and R⁸ are each, independently, a member selected from the group consisting of H and C₁ to C₄ alkyl;
R² and R⁶ are each, independently, C₁ to C₄ alkyl;
R³, R⁴, and R⁵ are each, independently, a member selected from the group consisting of methyl and phenyl; and
R⁷ is C₁ to C₁₀ alkylene.

3. The composition of claim 1, further comprising a moisture-cure catalyst.

4. The reaction product of the composition of claim 3, upon exposure to moisture.

5. The composition of claim 1, further comprising a filler.

6. A method for making a composition, the method comprising the steps of:
a) mixing:
i. a polymer of Formula (III): 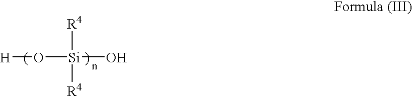
wherein
R⁴ in each occurrence is the same or different and is a C₁ to
C₁₀ hydrocarbon radical;
n is 1 to about 1,200; with
ii. at least two equivalents of a compound of Formula (IV): 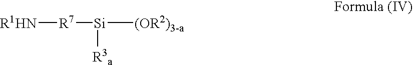
wherein
R¹ is a member selected from the group consisting of H and a C₁ to C₁₀ hydrocarbon radical;
R² and R³ are each, independently, a C₁ to C₁₀ hydrocarbon radical;
R⁷ is a C₁ to C₁₀ hydrocarbon diradical; and
a is 0, 1, or 2; and
b) mixing the reaction product of step a) with at least two equivalents of a compound of Formula (V): 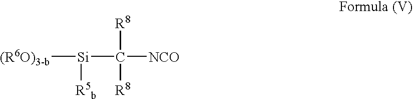
wherein
R⁵ and R⁶ are each, independently, a C₁ to C₁₀ hydrocarbon radical;
R⁸ in each occurrence is the same or different and is a member selected from the group consisting of H and a C₁ to C₁₀ hydrocarbon radical; and
b is 0 or 1.

7. The method of claim 6, wherein the compound of Formula (IV) is present in an amount of at least two equivalents.

8. The method of claim 6, wherein the compound of Formula (V) is present in an amount of at least two equivalents.

9. A method for making a composition, the method comprising the step of reacting:
i. a polymer having of Formula (II): 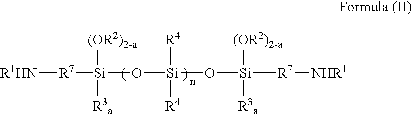
wherein
R¹ is a member selected from the group consisting of H and a C₁ to C₁₀ hydrocarbon radical
R², R³, and R⁴ are each, independently, a C₁ to C₁₀ hydrocarbon radical;
R⁷ in each occurrence may be the same or different and is a C₁ to C₁₀ hydrocarbon diradical;
n is 1 to about 1,200; and
a is 0, 1, or 2; with
ii. at least two equivalents of a compound of Formula (V): 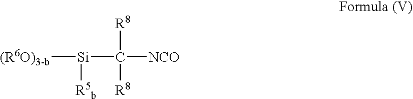
wherein
R⁵ and R⁶ are each, independently, a C₁ to C₁₀ hydrocarbon radical;
R⁸ in each occurrence is the same or different and is a member selected from the group consisting of H and a C¹ to C¹⁰ hydrocarbon radical; and
b is 0 or 1.

10. A composition comprising the reaction product of:
a) the reaction product of:
i. a polymer of Formula (III): 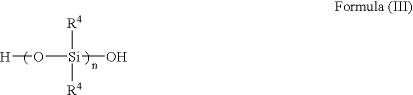
wherein
R⁴ is a C₁ to C₁₀ hydrocarbon radical; and
n is 1 to about 1,200; and
ii. a compound of Formula (IV): 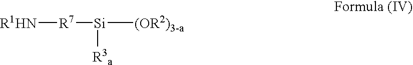
wherein
R¹ is a member selected from the group consisting of H and a C₁ to C₁₀ hydrocarbon radical;
R² and R³ are each, independently, a C₁ to C₁₀ hydrocarbon radical;
R⁷ in each occurrence may be the same or different and is a C₁ to C₁₀ hydrocarbon diradical; and
a is 0, 1, or 2; and
b) a compound of Formula (V): 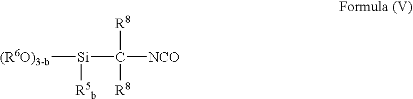
wherein
R⁵ and R⁶ are each, independently, a C₁ to C₁₀ hydrocarbon radical;
R⁸ in each occurrence is the same or different and is a member selected from the group consisting of H and a C¹ to C¹⁰ hydrocarbon radical; and
b is 0 or 1.

11. A composition comprising the reaction product of:
i. a polymer having of Formula (II): 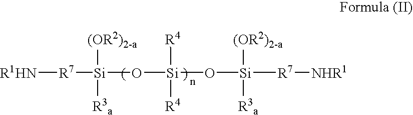
wherein
R¹ is a member selected from the group consisting of H and a C₁ to C₁₀ hydrocarbon radical
R², R³, and R⁴ are each, independently, a C₁ to C₁₀ hydrocarbon radical;
R⁷ in each occurrence may be the same or different and is a C₁ to C₁₀ hydrocarbon diradical;
n is 1 to about 1,200; and
a is 0, 1, or 2; and
ii. at least two equivalents of a compound of Formula (V): 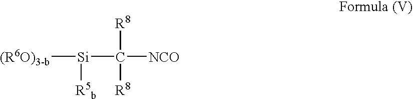
wherein
R⁵ and R⁶ are each, independently, a C₁ to C₁₀ hydrocarbon radical;
R⁸ in each occurrence is the same or different and is a member selected from the group consisting of H and a C₁ to C₁₀ hydrocarbon radical; and
b is 0 or 1.

12. A method of using a composition comprising a polymer of Formula (I): 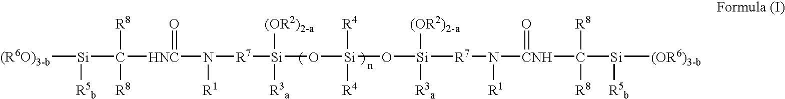
wherein
R¹ and R⁸ are each, independently, a member selected from the group consisting of H and a C₁ to C₁₀ hydrocarbon radical;
R², R³, R⁴, R⁵, and R⁶ are each, independently, a C₁ to C₁₀ hydrocarbon radical;
R⁷ in each occurrence may be the same or different is a C₁ to C₁₀ hydrocarbon diradical;
n is 1 to about 1,200;
a is 0, 1, or 2; and
b is 0 or 1,
the method comprising the steps of:
a) providing the composition;
b) applying the composition onto a substrate;
c) and permitting the composition to cure.

13. The method of claim 12, wherein the composition further comprises a moisture-cure catalyst.

14. The method of claim 12 wherein step a) includes providing the composition in a sealed container.
